(19) United States
(12) Patent Application Publication
(10) Pub. No.: US 2004/0003888 A1
(43) Pub. Date: Jan. 8, 2004

(54) Process for the manufacture of an improved floor element

(76) Inventors: Laurence Mott, Trelleborg (SE); Roger Hwatz, Grabo (SE)

Correspondence Address: STEVENS DAVIS MILLER & MOSHER, LLP, 1615 L STREET, NW, SUITE 850, WASHINGTON, DC, 20036, US

(21) Appl. No.: 10/421,957

(22) Filed: Apr. 24, 2003

Related U.S. Application Data
(63) Continuation-in-part of application No. 09/902,486, filed on Jul. 11, 2001, now abandoned.
(60) Provisional application No. 60/217,017, filed on Jul. 11, 2000.

(51) Int. Cl. B32B 31/00

(52) U.S. Cl. 156/269; 156/307.3

(57) ABSTRACT

A process for the manufacture of a floor element, which floor element comprises an upper decorative surface, a lower surface, core forming a carrying structure and edges intended for joining. An upper surface web and a lower surface web is fed between the belts of a continuous belt press. A mixture comprising at least one di, tri or polyhydric alcohol and at least one isocyanate, having an isocyanate functionality at least two, in a ratio yielding a polyurethane with a density in the range of 600-1400 kg/m³ is applied between the upper surface web and the lower surface web while said webs are fed between the belts of the continuous belt press. The belts are arranged to allow a substantially uniform and specified material thickness to form, whereby a polyurethane core is formed between said surface webs and whereby said surface webs bond to said core. The produced product is subsequently cut into boards or tiles and provided with edges comprising joining means, such as tongue, groove or the like, whereby an impact and moisture resistant floor element is obtained.

### CROSS-REFERENCE TO RELATED APPLICATIONS

This is a continuation-in-part of Ser. No. 09/902,386, filed Jul. 11, 2001, now abandoned, which application claims the benefit of provisional application serial No. 60/217,017, filed Jul. 11, 2000, the entire disclosures of which are herein incorporated by reference.

### BACKGROUND OF THE INVENTION

1. Field of the Invention

A process for the manufacture of an improved floor element.

The present invention relates to a process for manufacture of a floor element comprising a decorative thermosetting laminate.

2. Description of the Related Art

Products clad with thermosetting laminates are quite common nowadays. They are most often used where the demand for abrasion resistance is great, but also where resistance towards different chemical substances and moisture is required. Floors, floor skirtings, work tops, table tops, doors and wall panels can serve as examples of such products. The thermosetting laminate is most often made from a number of base sheets and a decorative sheet placed closest to the surface. The decorative sheet may be provided with the desired decor or pattern. Thicker laminates are often provided with a core of particle board or fibre board where both sides are covered with sheets of thermosetting laminate. The outermost sheet is, on at least one side, most often a decorative sheet.

One problem with such thicker laminates is that the core is much softer than the surface layer which is made from paper impregnated with thermosetting resin. This will cause a considerably reduced resistance towards thrusts and blows compared to a laminate with a corresponding thickness made of paper impregnated with thermosetting resin only.

Another problem with thicker laminates with a core of particle board or fibre board is that these normally will absorb a certain amount of moisture, which will cause them to expand and soften whereby the laminate will warp. The surface layer might even, partly or completely come off in extreme cases since the core will expand more than the surface layer. This type of laminate product can therefore not be used in humid areas, such as bath rooms or kitchens, without problem.

The problems can be partly solved by making the core of paper impregnated with thermosetting resin as well. Such a laminate is most often called compact laminate. These compact laminates are, however, very expensive and laborious to obtain as several tens of layers of paper have to be impregnated, dried and put in layers. The direction of the fibre in the paper does furthermore cause a moisture and temperature difference relating expansion. This expansion is two to three times as high in the direction crossing the fibre than along the fibre. The longitudinal direction of the fibre is coinciding with the longitudinal direction of the paper. One will furthermore be restricted to use cellulose as a base in the manufacturing though other materials could prove suitable.

### SUMMARY OF THE INVENTION

The above problems have through the present invention been solved whereby a flexible process for the manufacture of a floor element, comprising a mainly isometric thermosetting laminate has been obtained, wherein with radically improved impact resistance, rigidity and moisture resistance is produced. Accordingly, the invention relates to a process for the manufacturing of a floor element, which floor element comprises an upper decorative surface, a lower surface, a core forming a carrying structure and edges intended for joining. The invention is characterised in the steps of;

i) applying a mixture comprising at least one di, tri or polyhydric alcohol and at least one isocyanate, having an isocyanate functionality of at least two, in a ratio yielding a polyurethane having a density in the range of 600-1400 kg/m³, between an upper surface web and a lower surface web while said surface webs are being fed through a continuous belt press;

ii) allowing the belt press to continuously form a uniform and specified material thickness, whereby said mixture forms a polyurethane core between said surface webs and whereby said webs bond to said core; and optionally

iii) cutting obtained product into boards or tiles and providing edges comprising joining means, such as a tongue and groove joint.

The mixture forming the core may further comprise for example a small amount of blowing agent and/or a flame retardant comprising for example halogens, such as a trichlorophosphate.

### DETAILED DESCRIPTION OF THE PREFERRED EMBODIMENTS

Suitable isocyanate reactive compounds to be used in the process of the present invention include any of those known in the art for the preparation of rigid polyurethane or urethane-modified polyisocyanurate foams. Suitable isocyanate reactive compounds have been fully described in the prior art and include di, tri and polyhydric compounds, such as glycerol, sorbitol, sucrose, 2-hydroxyalkyl-1,3-propanediols, 2-alkyl-2-hydroxyalkyl-1,3-propanediols, 2,2-dihydroxyalkyl-1,3-propanediols, 2-hydroxyalkoxy-1,3-propanediols, 2-alkyl-2-hydroxyalkoxy-1,3-propanediols and 2,2-dihydroxyalkoxy-1,3-propanediols, which includes trimetylolethane, trimethylolpropane and pentaerythritol. Suitable isocyanate reactive compounds include furthermore dimers, trimers and polymers of said di, tri or polyhydric alcohols as well as alkoxylated species thereof. Further suitable isocyanate reactive compounds are to be found among mixtures of alcohols having average hydroxyl numbers of from 100 to 1000, especially from 100 to 700 mg, KOH/g, and hydroxyl functionalities of from 2 to 8, especially from 3 to 8. Other suitable polyhydric compounds include hydroxyfunctional polyesters obtained by the condensation of appropriate proportions of glycols and higher functionality polyols with dicarboxylic or polycarboxylic acids. Still further suitable polyhydric compounds include hydroxyl terminated polythioethers, polyamides, polyesteramides, polycarbonates, polyacetals, polyolefins, polysiloxanes as well as starbranched, hyperbranched and dendritic polyester and polyether alcohols. Suitable isocyanate reactive compounds also include reaction products of alkylene oxides, for example ethylene oxide and/or propylene oxide, with initiators having from 2 to 8 active hydrogens per molecule. Suitable initiators include for example di, tri and polyhydric compounds as disclosed above, polyamines, for example ethylene diamine, toluene diamine (TDA), diamino diphenylmethane (DADPM) and polymethylene or polyphenylene polyamines, and aminoalcohols, for example ethanolamine, diethanolamine and triethanolamine, and mixtures of such initiators.

Suitable organic isocyanates, having an isocyanate functionality of two or more, for use in the process of the present invention include any of those known in the art for the preparation of rigid polyurethane foams and elastomers, and in particular aromatic isocyanates, such as diphenylmethane diisocyanate in the form of its 2,4, 2,2, and 4,4 isomers and mixtures thereof, the mixtures of diphenylmethane diisocyanates (MDI) and oligomers thereof known in the art as “crude” or polymeric MDI (polymethylene polyphenylene polyisocyanates) having an isocyanate functionality of greater than 2, toluene diisocyanate in the form of its 2,4 and 2,6 isomers and mixtures thereof, 1,5-naphthalene diisocyanate and 1,4-diisocyanatobenzene. Other organic isocyanates which may be mentioned include aliphatic diisocyanates, such as isophorone diisocyanate, 1,6-diisocyanatohexane and 4,4-diisocyanato-dicyclohexylmethane.

The suitable proportions, in a polyurethane producing mixture, between said isocyanates and said isocyanate reactive compounds will depend upon the nature of the rigid polyurethane or urethane-modified polyisocyanurate foam to be produced and will be readily determined by those skilled in the art.

The water captured in the raw materials (especially the di, tri or polyhydric alcohols) may be used as blowing agent, when properly monitored. Should the raw materials be desiccated before use a micro-dosage of commonly used blowing agent is preferred. Blowing agents proposed in the prior art include hydrochlorofluorocarbons, hydrofluorocarbons and especially hydrocarbons, namely alkanes and cycloalkanes, such as iso-butane, n-pentane, iso-pentane, cyclopentane and mixtures thereof as well as water or for instance any carbon dioxide evolving compound.

In addition to said isocyanate, said isocyanate reactive compound and said blowing agent, the polyurethane forming mixture will commonly contain one or more other auxiliaries or additives conventional to formulations for the production of rigid polyurethane foams and elastomers. Such optional additives include crosslinking agents, for example low molecular weight polyhydric compounds, such as triethanolamine, foam-stabilising agents or surfactants, for example siloxane-oxyalkylene copolymers, urethane catalysts, for example tin compounds, such as stannous octoate or dibutyltin dilaurate, or tertiary amines, such as dimethylcyclohexylamine or triethylene diamine, fire retardants, for example halogenated alkylphosphates, such as trischloropropylphosphate, color pigmentation and fillers.

It is also possible to adapt the mechanical properties of the produced polyurethane core by adding, to said mixture, other materials, such as particles or fibre. These type of additives can be used for a number of reasons. Additives may be used to alter, adjust or improve acoustic properties, density, thermal coefficient of expansion, thermal conductivity, flexibility, rigidity and/or brittleness. A proper filler may also reduce the manufacturing costs. Typical particle fillers are minerals, such as mica and lime, while common fibre fillers are glass, carbon, steel, aramide and cellulose fibres.

According to an embodiment of the invention, the upper surface web, being a decorative upper surface, is manufactured by laminating under heat and pressure at least one uppermost so-called overlay web of melamine-formaldehyde resin impregnated α-cellulose paper with at least one decorative web of decorated melamine-formaldehyde resin impregnated α-cellulose paper and optionally at least one support webs. The resin cures at least partially and the webs are bonded to one another, preferably while the polyurethane core is formed.

Support layer webs are preferably forming a part of the decorative upper surface. These support layer webs then comprise one or more monochromatic webs made of α-cellulose impregnated with melamine-formaldehyde resin and/or one or more Kraft-paper webs impregnated with phenol-formaldehyde resin, urea-formaldehyde resin, melamine-formaldehyde resin or combinations thereof.

In order to improve abrasion resistance the overlay webs and optionally the decorative paper webs preferably includes 2-100 g/m² of hard particles of α-aluminum oxide, silicon carbide or silicon oxide having an average particle size in the range of 50 nm to 150 μm. Scratch resistance may be improved by applying 2-100 g/m² of hard particles of α-aluminum oxide, silicon carbide or silicon oxide having an average particle size in the range of 50 nm to 30 μm on the upper surface of the uppermost overlay web.

The decorative upper surface is optionally laminated and at least partially cured prior to the part of the process where the core is obtained and bonded to the decorative upper surface web. It is then preferable to increase the pressure in the press towards the end of pressing cycle.

According to another embodiment of the invention, the upper surface web is a printed foil. This printed foil is for instance made of α-cellulose impregnated with a polymeric lacquer or resin, such as melamine-formaldehyde, urea-formaldehyde, acrylic, maleamide, polyurethane or the like. The printed foil may furthermore be made of a polymer, such as polyvinylchloride, polyester, polypropylene, polyethylene, polyurethane, acrylic or the like. The uppermost surface is then preferably coated with one or more wear-resistant layers of acrylic or maleamide lacquer on top of the printed foil after having passed through the continuous belt press. The lacquer is preferably of a UV or electron-beam curing type. Such a lacquer is preferably applied in two or more layers with intermediate stages of partial or complete curing. In order to improve the abrasion resistance even further the lacquer may include 2-100 g/m² of hard particles of α-aluminum oxide, silicon carbide or silicon oxide having an average particle size in the range of 50 nm to 150 μm. These particles may be mixed with the lacquer prior to the coating and/or sprinkled on top of a still fluid coating. An improved scratch resistance is obtained by applying 2-100 g/m² of hard particles of α-aluminum oxide, silicon carbide or silicon oxide having an average particle size in the range of 50 nm to 30 μm on the upper surface of the uppermost layer of lacquer.

In yet a further embodiment, the upper surface web is a translucent or semi-translucent layer wherein for instance particles with sizes in the range 0.5-10 mm are applied. The semi-translucent layer is optionally a foil or a web provided with a printed decor. The printed decor is suitably semi-translucent. It is also possible to use a printed decor which is opaque, covering only parts of the surface of the foil or web. Such a semi-translucently decorated foil or web will increase the image of depth in the decorative upper surface. The semi-translucent foil or web is suitably made of α-cellulose impregnated with a polymeric resin or lacquer, such as melamine-formaldehyde, urea-formaldehyde, polyurethane, acrylic or maleamide. It may also be made of a polymer, such as polyvinylchloride, acrylic, polyester, polypropylene, polyethylene, polyurethane or the like. To increase the wear resistance, at least one wear layer is suitably applied on top of the foil or web. The wear layer is suitably made of a-cellulose impregnated with a polymeric resin or lacquer, such as melamine-formaldehyde, urea-formaldehyde, polyurethane, acrylic or maleamide. The wear layer may also be obtained by applying a coat of lacquer, such as acrylic or maleamide, of for instance a UV or electron-beam curing type. Such an energy curable lacquer is suitably applied in two or more layers with intermediate stages of partial or complete curing. To further increase the abrasion resistance the lacquer preferably includes 2-100 g/m² per layer of hard particles of a-aluminum oxide, silicon carbide or silicon oxide having an average particle size in the range 50 nm-150 μm. The scratch resistance can be increased by applying 2-100 g/m² of hard particles of α-aluminum oxide, silicon carbide or silicon oxide having an average particle size in the range 50 nm-30 μm on the upper surface of the uppermost layer of lacquer. To increase the design options the mixture yielding the polyurethane resin may comprise a pigmentation.

According to yet another embodiment of the invention, a decor is applied on the upper side of the upper surface web. The decor is printed directly on the surface or applied on the surface via transfer printing. At least one wear layer is preferably applied on top of the decor. The wear layer is suitably made of a-cellulose impregnated with a polymeric resin or lacquer such as melamine-formaldehyde, urea-formaldehyde, polyurethane, acrylic or maleamide. The wear layer may also be obtained by coating a layer of for instance a UV or electron-beam curing lacquer, such as acrylic or maleamide. Such an energy curable lacquer is suitably applied in two or more layers with intermediate stages of partial or complete curing. To increase the wear resistance, 2-100 g/m² per layer of hard particles of α-aluminum oxide, silicon carbide or silicon oxide having an average particle size in the range of 50 nm to 150 μm, are added. To increase the scratch resistance 2-100 g/m² of hard particles of α-aluminum oxide, silicon carbide or silicon oxide having an average particle size in the range 50 mm to 30 μm maybe applied on the upper surface of the uppermost layer of lacquer.

We claim:

1. A process for the manufacture of a floor element, which floor element comprises an upper surface, a lower surface, a core forming a carrying structure and edges intended for joining two or more floor elements into a floor, comprising; i) applying a mixture of at least one polyol and at least one isocyanate, having an isocyanate functionality of at least two, in a ratio yielding a polyurethane with a density in the range of 600-1400 kg/m³, between an upper surface web and a lower surface web while said surface webs are being fed through a continuous belt press; ii) allowing the belt press to continuously form a uniform and specified material thickness, whereby said mixture forms a polyurethane core between said surface webs and whereby said surface webs bond to said core.

2. A process according to claim 1, further comprising the step of iii) cutting in step (ii) produced product into boards or tiles and providing edges comprising joining means.

3. The process according to claim 2, wherein the joining means on said edges comprises a tongue and groove joint.

4. A process according to claim 1, wherein said mixture further comprises a blowing agent.

5. A process according to claim 1, wherein said mixture further comprises a flame retardant.

6. A process according to claim 1, wherein the upper surface web provides a decorative upper surface.

7. A process according to claim 6, wherein the upper surface web is manufactured by laminating together under heat and pressure at least one uppermost so-called overlay web of melamine-formaldehyde resin impregnated α-cellulose paper and at least one decorative web of decorated melamine-formaldehyde resin impregnated α-cellulose paper and allowing the resin to at least partially.

8. A process according to claim 7, wherein at least one support web is laminated together with said overlay web and said decorative web.

9. A process according to claim 8, wherein the support web forms a part of the decorative upper surface, and wherein the support web comprises one or more monochromatic webs of α-cellulose impregnated with melamine-formadehyde resin or one or more Kraft-paper webs impregnated with phenol-formaldehyde resin, urea-formaldehyde resin, melamine-formaldehyde resin or combinations thereof.

10. A process according to claim 7, wherein the overlay web comprises 2-100 g/m² of hard particles of α-aluminum oxide, silicon carbide or silicon oxide having an average particle size in the range 50 nm-150 μm.

11. A process according to claim 7, wherein the decorative web comprises 2-100 g/m² of hard particles of α-aluminum oxide, silicon carbide or silicon oxide having an average particle size in the range 50 nm-150 μm.

12. A process according to claim 1, wherein the upper surface web is a printed foil.

13. A process according to claim 12, wherein the printed foil is made of α-cellulose impregnated with a polymeric lacquer or resin selected from the group consisting of melamine-formaldehyde, urea-formaldehyde, acrylic, maleamide, polyurethane and mixtures thereof.

14. A process according to claim 12, wherein the printed foil is made of a polymer selected from the group consisting of polyvinylchloride, polyester, polypropylene, polyethylene, polyurethane, acrylic and mixtures thereof.

15. A process according to claim 12, further comprising coating the upper surface with one or more wear-resistant layers of acrylic or maleamide lacquer on top of the printed foil after having passed through the continuous belt press.

16. A process according to claim 15, further comprising the step of exposing the lacquer to UV- or electron-beam radiation.

17. A process according to claim 15, including applying the lacquer in two or more layers with intermediate stages of partial or complete curing.

18. A process according to claim 12, wherein the lacquer comprises 2-100 g/m² of hard particles of α-aluminum oxide, silicon carbide or silicon oxide having an average particle size in the range of 50 nm-150 μm.

19. A process according to claim 1, wherein the upper surface web is a translucent or semi-translucent layer wherein particles with sizes in the range 0.5-10 mm are applied.

20. A process according to claim 19, wherein the particles deviate in color from the polyurethane resin.

21. A process according to claim 20, wherein the mixture yielding the polyurethane resin further comprises a pigmentation.

22. A process according to claim 19, wherein the semi-translucent layer is a foil or web provided with a printed decor.

23. A process according to claim 22, wherein the printed decor is semi-translucent.

24. A process according to claim 22, wherein the printed decor is opaque, covering only parts of the surface of the foil or web.

25. A process according to claim 19, wherein the semi-translucent foil or web is made of α-cellulose impregnated with a polymeric resin or lacquer selected from the group consisting of melamine-formaldehyde, urea-formaldehyde, polyurethane, acrylic or maleamide.

26. A process according to claim 19, wherein the semi-translucent foil or web is made of a polymer selected from the group consisting of polyvinylchloride, acrylic, polyester, polypropylene, polyethylene, polyurethane and mixtures thereof.

27. A process according to claim 19, further comprising the step of applying at least one wear layer on top of the foil or web.

28. A process according to claim 27, wherein the wear layer is made of α-cellulose impregnated with a polymeric resin or lacquer selected from the group consisting of melamine-formaldehyde, urea-formaldehyde, polyurethane, acrylic and maleamide.

29. A process according to claim 27, wherein the wear layer is obtained by coating on the foil or web a lacquer selected from the group consisting of acrylic and maleamide.

30. A process according to claim 29, including the step of coating the lacquer in two or more layers with intermediate stages of partial or complete curing.

31. A process according to claim 29, wherein the lacquer comprises 2-100 g/m² of hard particles of α-aluminum oxide, silicon carbide or silicon oxide having an average particle size in the range 5 nm-150 μm.

32. A process according to claim 1, further comprising the step of applying a decor on the upper surface of the upper surface web and that the decor is printed directly on the surface or applied on the surface via transfer printing.

33. A process according to claim 32, including applying at least one wear layer on top of the decor.

34. A process according to claim 33, wherein the wear layer is made of α-cellulose impregnated with a polymeric resin or lacquer selected from the group consisting of melamine-formaldehyde, urea-formaldehyde, polyurethane, acrylic and maleamide.

35. A process according to claim 33, wherein the wear layer is obtained by coating on top of the decor a lacquer selected from the group consisting of acrylic and maleamide.

36. A process according to claim 35, including the step of applying the lacquer in two or more layers with intermediate stages of partial or complete curing.

37. A process according to claim 35, wherein the lacquer comprises 2-100 g/m² of hard particles of α-aluminum oxide, silicon carbide or silicon oxide having an average particle size in the range 50 nm-150 μm.

38. A process according to claim 1, wherein said polyurethane producing mixture comprises at least one di, tri or polyhydric alcohol selected from the group consisting of a 2-hydroxyalkyl-1,3-propanediol, a 2-alkyl-2-hydroxyalkyl- -1,3-propanediol, a 2,2-dihydroxyalkyl-1,3-propanediol, a 2-hydroxyalkoxy-1,3-propanediol, a 2-alkyl-2-hydroxyalkoxy-1,3-propanediol and a 2,2-dihydroxyalkoxy-1,3-propanediol.

39. A process according to claim 1, wherein said polyurethane producing mixture comprises at least one di, tri or polyhydric alcohol selected from the group consisting of glycerol, sorbitol, sucrose, trimetylolethane, trimethylolpropane and pentaerythritol.

40. A process according to claim 38 or 39, wherein said polyurethane producing mixture comprises at least one dimer, trimer or polymer of a said di, tri or polyhydric alcohol.

41. A process according to claim 38 or 39, wherein said polyurethane producing mixture comprises at least one alkoxylated species of a said di, tri or polyhydric alcohol.

42. A process according to claim 1, wherein said polyurethane producing mixture comprises at least one hydroxyl terminated polythioether, polyamide, polyesteramide, polycarbonate, polyacetal, polyolefin, polysiloxane or starbranched, hyperbranched or dendritic polyester or polyether.

43. A process according to claim 1, wherein said polyurethane producing mixture comprises a mixture of alcohols having average hydroxyl numbers of from 100 to 1000 and hydroxyl functionalities of from 2 to 8.

44. A process according to claim 43, wherein said polyurethane producing mixture comprises a mixture of alcohols having average hydroxyl numbers of from 100 to 700 and hydroxyl functionalities of from 3 to 8.

45. A process according to claim 1, wherein said polyurethane producing mixture comprises at least one reaction product of at least one alkylene oxide with at least one initiator having from 2 to 8 active hydrogens per molecule.

46. A process according to claim 1, wherein said alkylene oxide is ethylene oxide or propylene oxide.

47. A process according to claim 45 or 46, wherein said initiator is selected from the group consisting of a 2-hydroxyalkyl-1,3-propanediol, a 2-alkyl-2-hydroxyalkyl-1,3-propanediol, a 2,2-dihydroxyalkyl-1,3-propanediol, a 2-hydroxyalkoxy-1,3-propanediol, a 2-alkyl-2- -hydroxyalkoxy-1,3-propanediol and a 2,2-dihydroxyalkoxy-1,3-propanediol.

48. A process according to claim 45 or 46, wherein said initiator is selected from the group consisting of a polyamine, a polymethylene polyamine, a polyphenylene polyamine and a aminoalcohol.

49. A process according to claim 45 or 46, wherein said initiator is selected from the group consisting of ethylene diamine, toluene diamine, diamino diphenylmethane, ethanolamine, diethanolamine, triethanolamine and mixtures thereof.

50. A process according to claim 1, wherein said polyurethane producing mixture comprises at least one isocyanate selected from the group consisting of 2,4-diphenylmethane diisocyanate 2,2-diphenylmethane diisocyanate, 4,4-diphenylmethane diisocyanate, 2,4-toluene diisocyanate, 2,6-toluene diisocyanate, 1,5-naphthalene diisocyanate, 1,4-diisocyanatobenzene and mixtures thereof.

51. A process according to claim 50, wherein said polyurethane producing mixture comprises crude methylene diphenyl diisocyanate.
